(19) United States
(12) Patent Application Publication
(10) Pub. No.: US 2010/0266316 A1
(43) Pub. Date: Oct. 21, 2010

(54) TRANSFERRING AND FIXING DEVICE FOR PERFORMING FIXATION SIMULTANEOUSLY WITH TRANSFER

(75) Inventors: Ryota SAEKI, Shizuoka (JP); Satoshi KINOUCHI, Tokyo (JP); Toshihiro SONE, Kanagawa (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/755,073

(22) Filed: Apr. 6, 2010

Related U.S. Application Data
(60) Provisional application No. 61/170,577, filed on Apr. 17, 2009.

(51) Int. Cl. G03G 15/16

(52) U.S. Cl. 399/307; 399/319

(57) ABSTRACT

A transferring and fixing device includes an image carrier member to hold an unfixed toner image, a heat member to heat the unfixed toner image on the image carrier member, a pressure member which comes in press contact with the image carrier member, nips a recording medium with the image carrier member, and presses and conveys the recording medium, and a vibrating member to transmit vibrations to the recording medium passing through between the image carrier member and the pressure member.

### CROSS-REFERENCE TO RELATED APPLICATIONS

This application is based upon and claims the benefit of priority from Provisional U.S. Application 61/170,577 filed on Apr. 17, 2009, the entire contents of which are incorporated herein by reference.

### TECHNICAL FIELD

The present invention relates to a transferring and fixing device which is used in an image forming apparatus such as a copying machine or an MFP (multi-function peripheral) and fixes a toner image simultaneously with transfer of the toner image to a recording medium.

### BACKGROUND

There is an image forming apparatus provided with a transferring and fixing device which heats an un-fixed toner image held on a transfer belt or a transfer roller and transfers the toner image from the transfer belt or the transfer roller to a sheet, and simultaneously fixes it. For example, JP-A-6-258895 discloses a device in which a visible image transferred to a first transfer unit is heated by an infrared heating unit, and the half-melted visible image is transferred from the first transfer unit to a transfer sheet by adhesion forces and is simultaneously fixed.

However, in the above device, there is a fear that when the visible image is transferred to the transfer sheet, transfer residue occurs on the first transfer unit, and uneven transfer occurs in the image on the transfer sheet.

Accordingly, it is desired to develop a transferring and fixing device which certainly transfers an unfixed toner image on a transfer belt or a transfer roller to a sheet and simultaneously fixes it.

### SUMMARY

An aspect of the present invention is to improve a transfer property of a toner image when an unfixed toner image on an image carrier member is fixed simultaneously with transfer to a sheet.

According to an embodiment, a transferring and fixing device includes an image carrier member to hold an unfixed toner image, a heat member to heat the unfixed toner image on the image carrier member, a pressure member which comes in press contact with the image carrier member, nips a recording medium with the image carrier member, and presses and conveys the recording medium, and a vibrating member to transmit vibrations to the recording medium passing through between the image carrier member and the pressure member.

### DESCRIPTION OF THE DRAWINGS

FIG. 1 is a whole structural view showing an image forming apparatus of a first embodiment;

FIG. 2 is a schematic structural view showing a transferring and fixing device of the first embodiment;

FIG. 3 is a schematic explanatory view showing arrangement of ultrasonic vibrators of the first embodiment;

FIG. 4 is a schematic structural view showing a transferring and fixing device of a second embodiment;

FIG. 5 is a schematic structural view showing a transferring and fixing device of a third embodiment;

FIG. 6 is a schematic structural view in which a transferring and fixing device of a fourth embodiment is seen from the side surface of a transferring and fixing belt; and

FIG. 7 is a schematic explanatory view in which the transferring and fixing device of the fourth embodiment is seen from above.

### DETAILED DESCRIPTION

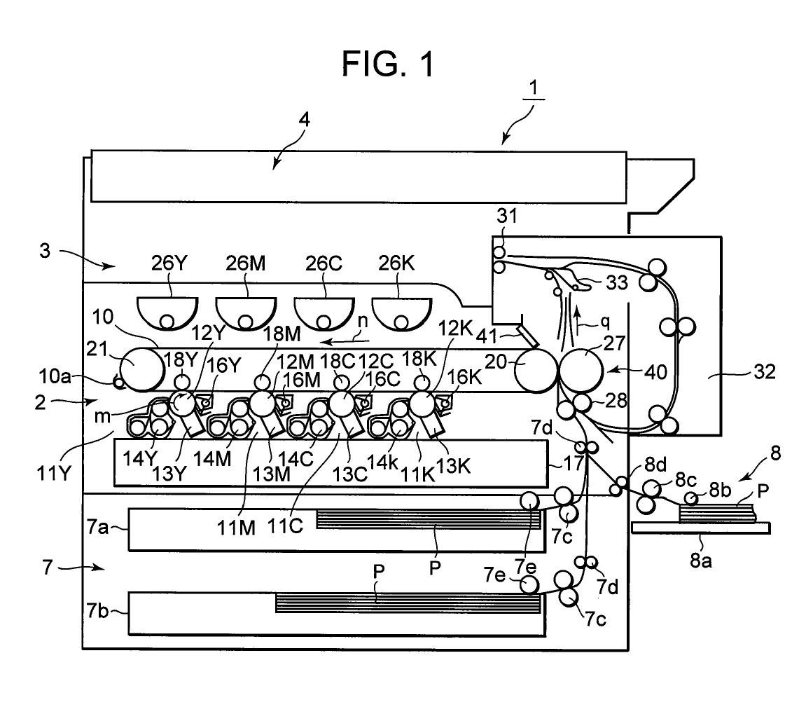

Hereinafter, a first embodiment will be described. FIG. 1 is a schematic structural view of a color printer 1 which is an image forming apparatus of this embodiment. The color printer 1 includes a printer section 2 to form an image, a paper discharge section 3 to receive a sheet P as a recording medium discharged from the printer section 2, a scanner section 4 to read a document image, a paper feeding device 7 to feed the sheet P, and a bypass paper feeding device 8.

The printer section 2 includes four sets of image forming stations 11Y, 11M, 11C and 11K which are image forming members. The four sets of image forming stations 11Y, 11M, 11C and 11K are arranged in parallel along the lower side of a transferring and fixing belt 10 which is an image carrier member and an intermediate transfer member. The image forming stations 11Y, 11M, 11C and 11K respectively form unfixed toner images of Y (yellow), M (magenta), C (cyan) and K (black) on respective photoconductive drums 12Y, 12M, 12C and 12K correspondingly to image information.

Each of the photoconductive drums 12Y, 12M, 12C and 12K rotates in an arrow m direction. Charging chargers 13Y, 13M, 13C and 13K, developing devices 14Y, 14M, 14C and 14K, and photoconductive cleaners 16Y, 16M, 16C and 16K are respectively arranged around the respective photoconductive drums 12Y, 12M, 12C and 12K along the rotation direction. The developing devices 14Y, 14M, 14C and 14K use, for example, a two-component developer including a magnetic carrier resin and a toner. Each toners of each two-component developer includes, for example, respective coloring agent of Y (yellow), M (magenta), C (cyan) or K (black). And the each toner further includes bonding resin, wax, charge control material and the like, and has an average diameter of 5 to 10 p.m.

Toner cartridges 26Y, 26M, 26C and 26K respectively containing toners of Y (yellow), M (magenta), C (cyan) and K (black) supply toners to the developing devices 14Y, 14M, 14C and 14K respectively. A laser exposure device 17 irradiates respective laser beams corresponding to image information to the respective charged photoconductive drums 12Y, 12M, 12C and 12K.

A heat roller 20 and a driven roller 21 support the transferring and fixing belt 10. The heat roller 20 rotates in an arrow r direction, and causes the transferring and fixing belt 10 to run in an arrow n direction. Primary transfer rollers 18Y, 18M, 18C and 18K are respectively arranged opposite to the photoconductive drums 12Y, 12M, 12C and 12K through the transferring and fixing belt 10. The respective primary transfer rollers 18Y, 18M, 18C and 18K primarily transfer unfixed toner images formed on the respective photoconductive drums 12Y, 12M, 12C and 12K to the transferring and fixing belt 10 by primary transfer bias. The respective photoconductive cleaners 16Y, 16M, 16C and 16K remove residual toners on the respective photoconductive drums 12Y, 12M, 12C and 12K after primary transfer.

The transferring and fixing belt 10 has such a structure that a surface layer made of PFA (Polytetrafluoroethylene) having a high contact angle and a smooth surface is laminated on a base member made of, for example, silicone resin. The transferring and fixing belt 10 can enhance the conductivity of heat from the heat roller 20 by using a material having a high thermal conductivity.

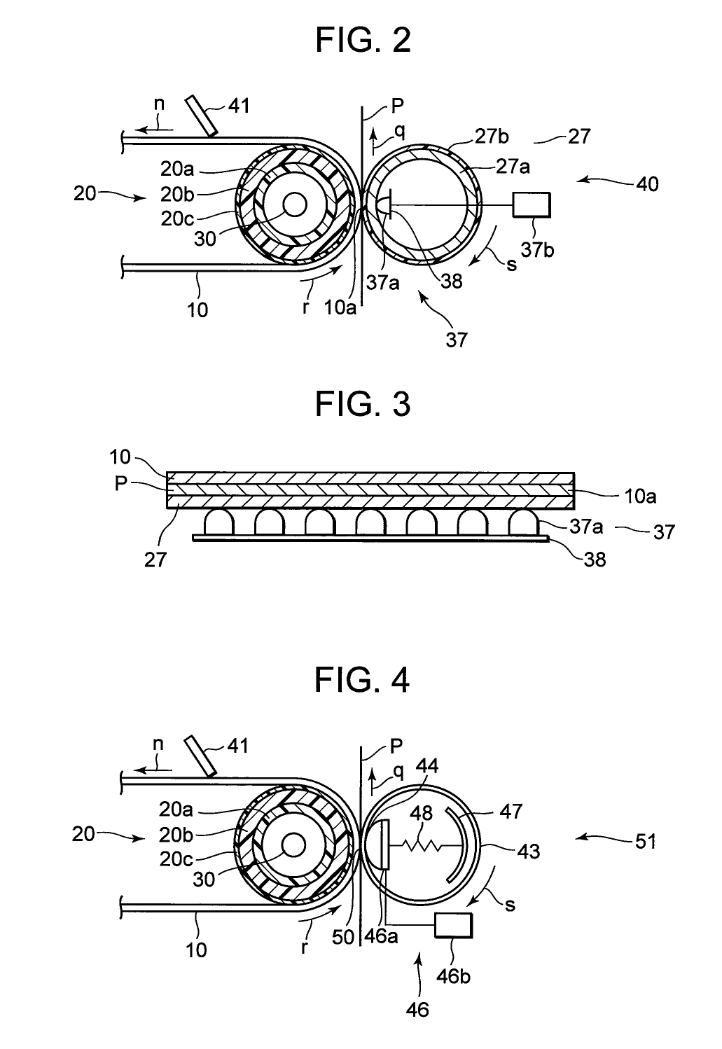

As shown in FIG. 2, the heat roller 20 includes a silicone resin layer 20b and a surface layer 20c of PFA or the like around a core metal 20a having a thickness of, for example, 0.8 mm. The heat roller 20 incorporates a halogen lamp 30 as a heat member in the hollow inside. At the time of transferring and fixing, the heat roller 20 keeps a temperature of, for example, 140° C., and heats the transferring and fixing belt 10 which contacts with the heat roller 20. In an area where the heat roller 20 backs up, the temperature of the heat roller 20 is conducted to the transferring and fixing belt 10, and the toner image on the transferring and fixing belt 10 is heated to a toner's glass transition temperature or higher.

A press roller 27 as a pressure member is arranged opposite to the heat roller 20 through the transferring and fixing belt 10, and rotates in an arrow s direction in accordance with the transferring and fixing belt 10. The press roller 27 includes a surface layer 27b of PFA or the like on a core metal 27a having a thickness of, for example, 2.5 mm. The press roller 27 comes in press contact with the transferring and fixing belt 10 backed up by the heat roller 20. The press roller 27 and the transferring and fixing belt 10 come in press contact with each other to form a nip 10a.

The temperature of the heat roller 20 is not limited to 140° C. as long as the toner image on the transferring and fixing belt 10 can be heated to the toner's glass transition temperature or higher. However, the toner image on the transferring and fixing belt 10 backed up by the heat roller 20 is heated before it reaches the nip 10a, and a heating time can be made long, and accordingly, the temperature of the heat roller 20 can be set to be relatively low.

An ultrasonic vibrating device 37 as a vibrating member contacts with the inner periphery of the press roller 27. The ultrasonic vibrating device 37 transfers minute vibrations in the direction of the nip 10a through the press roller 27. In the ultrasonic vibrating device 37, for example, as shown in FIG. 3, plural small ceramic oscillators 37a are arranged on a substrate 38 at regular intervals in the longitudinal direction of the press roller 27. The ceramic oscillators 37a oscillate ultrasonic waves of, for example, 20 to 100 kHz by voltage from an AC power source 37b.

A transferring and fixing device 40 includes the transferring and fixing belt 10, the heat roller 20, the press roller 27 and the ultrasonic vibrating device 37. The transferring and fixing device 40 heats the toner image on the transferring and fixing belt 10 to the toner's glass transition temperature or higher before the toner image reaches the nip 10a between the press roller 27 and the transferring and fixing belt 10. While the transferring and fixing belt 10 and the press roller 27 nip and convey the sheet P in an arrow q direction, the transferring and fixing device 40 transfers the toner image on the transferring and fixing belt 10 to the sheet P by the adhesion of the toner heated to the toner's glass transition temperature or higher. At the same time, the transferring and fixing device 40 vibrates the sheet P and the toner passing through the nip 10a by the ultrasonic waves oscillated by the ceramic oscillators 37a, and promotes the toner to penetrate into the sheet P. At the same time, the transferring and fixing device 40 heats, presses and fixes the sheet P passing through the nip 10a.

A cleaning blade 41 as a cleaning member adjacent to the transferring and fixing device 90 comes in slide contact with the transferring and fixing belt 10 and removes the residual toner before solidification from the transferring and fixing belt 10.

The paper feeding device 7 includes a first and a second paper feeding cassettes 7a and 7b. The sheet P taken out from each of the paper feeding cassettes 7a and 7b by a pickup roller 7e is supplied to the transferring and fixing device 40 by a separation roller 7c, a conveyance roller 7d and a registration roller pair 28. The bypass paper feeding device 8 supplies the sheet P taken out by a manual feed pickup roller 8b from a manual feed tray 8a to the transferring and fixing device 40 by a manual feed separation roller 8c, a manual feed conveyance roller 8d, the conveyance roller 7d and the registration roller pair 28. A gate 33 to distribute the sheet P in the direction of a paper discharge roller 31 or the direction of a re-conveyance unit 32 is disposed downstream of the transferring and fixing device 40. The re-conveyance unit 32 again guides the sheet P in the direction of the transferring and fixing device 40.

In the color printer 1, when a print process starts, after the charging chargers 13Y, 13M, 13C and 13K charge the respective photoconductive drums 12Y, 12M, 12C and 12K, the laser exposure device 17 irradiates exposure light to the respective photoconductive drums 12Y, 12M, 12C and 12K to form electrostatic latent images corresponding to the exposure light on the respective photoconductive drums 12Y, 12M, 12C and 12K. The developing devices 14Y, 14M, 14C and 14K apply toners to the electrostatic latent images on the photoconductive drums 12Y, 12M, 12C and 12K respectively. The primary transfer rollers 18Y, 18M, 18C and 18K successively overlappingly transfer toner images on the photoconductive drums 12Y, 12M, 12C and 12K to the transferring and fixing belt 10, and form a multiple toner image on the transferring and fixing belt 10.

The toner image on the transferring and fixing belt 10 backed up by the heat roller 20 is heated to the glass transition temperature or higher when reaching the nip 10a. The sheet P supplied from the paper feeding device 7 or the bypass paper feeding device 8 reaches the nip 10a in synchronization with the toner image on the transferring and fixing belt 10. The AC power source 37b is turned ON in synchronization with the arrival of the sheet P at the nip 10a, and the ceramic oscillators 37a oscillate ultrasonic waves. The ultrasonic waves are transmitted to the sheet P and the toner through the press roller 27.

While passing through the nip 10a, the toner image on the transferring and fixing belt 10 is transferred to the sheet P by the adhesion. The surface layer of the transferring and fixing belt 10 is made of smooth PFA, adhesion force to the toner is low as compared with the surface of the sheet P, and the toner image on the transferring and fixing belt 10 adheres to the sheet P. At this time, the ceramic oscillators 37a minutely vibrate the toner and the sheet P, so that the penetration of the toner into a gap between fibers of the sheet P is improved, and the toner remaining on the transferring and fixing belt 10 is reduced. While nipping and conveying the sheet P, the transferring and fixing device 10 and the press roller 27 heat, press and fix the toner image transferred on the sheet P.

The sheet P having the toner image subjected to the transferring and fixing is discharged to the paper discharge section 3 through the paper discharge roller 31, or is again guided to the direction of the transferring and fixing device 40 through the re-conveyance unit 32. The cleaning blade 41 removes the toner remaining on the transferring and fixing belt 10 after passing through the nip 10a. Next printing becomes possible in the transferring and fixing belt 10.

In the first embodiment, while the transferring and fixing belt 10 and the press roller 27 nip and convey the sheet P, the ultrasonic vibrating device 37 minutely vibrates the sheet P and the toner. When the toner image on the transferring and fixing belt 10 is transferred to the sheet P, the penetration of the toner into the sheet P is improved, the residual toner on the transferring and fixing belt 10 is decreased, the picture quality of the transferred toner image is improved, and the stain of the transferring and fixing belt 10 by the residual toner is reduced. Besides, the penetration of the toner into the sheet P is improved, and the fixing property of the toner image is improved.

Next, a second embodiment will be described. The second embodiment is different from the first embodiment in the structure of a pressure member. In the second embodiment, the same component as the component described in the first embodiment is denoted by the same reference numeral and its detailed description is omitted.

As shown in FIG. 4, a press tube 43 constituting a pressure member and made of a flexible member is arranged opposite to a heat roller 20 through a transferring and fixing belt 10. The press tube 43 includes a surface layer of PFA or the like on a nickel surface of a thickness of, for example, 200 μm. Further, the inner periphery of the press tube 43 has an inner peripheral surface of smooth PFA or the like having a high contact angle. A pressure pad 44 is disposed in the inside of the press tube 43 and at a position opposite to the transferring and fixing belt 10 backed up by the heat roller 20. The pressure pad 44 has almost the same length as the press tube 43 in the longitudinal direction. The pressure pad 44 is formed of aluminum, synthetic resin having high hardness or synthetic rubber. An ultrasonic vibrating device 46 as a vibrating member is in close contact with the back surface of the pressure pad 44.

A support mechanism 47 supports the pressure pad 44 in the inside of the press tube 43. A spring 48 of the support mechanism 47 applies tension to the pressure pad 44 in the direction of the transferring and fixing belt 10. The pressure pad 44 causes the press tube 43 to come in press contact with the transferring and fixing belt 10 by the support mechanism 47, and forms a nip 50 between the press tube 43 and the transferring and fixing belt 10.

In the ultrasonic vibrating device 46, for example, plural small ceramic oscillators 46a are attached to the pressure pad 44 at regular intervals in the longitudinal direction of the press tube 43. The ultrasonic vibrating device 46 may be a single ceramic oscillator as long as minute vibrations can be uniformly transmitted to the pressure pad 44 over the whole length of the press tube 43 in the longitudinal direction. The ceramic oscillators 46a oscillate ultrasonic waves of, for example, 20 to 100 kHz by voltage from an AC power source 46b.

A transferring and fixing device 51 includes the transferring and fixing belt 10, the heat roller 20, the press tube 43, the pressure pad 44, the ultrasonic vibrating device 46 and the support mechanism 47. In an area where the heat roller 20 backs up, the transferring and fixing device 51 heats a toner image on the transferring and fixing belt 10 to the toner's glass transition temperature or higher before the toner image reaches the nip 50. The transferring and fixing device 51 turns on the AC power source 46b in synchronization with the arrival of a sheet P at the nip 50, and transmits the ultrasonic waves oscillated by the ceramic oscillators 46a to the sheet P and the toner through the pressure pad 44 and the press tube 43.

While passing through the nip 50, the toner image heated to the toner's glass transition temperature or higher on the transferring and fixing belt 10 is transferred to the sheet P by the adhesion. At the same time, the ceramic oscillators 46a minutely vibrate the sheet P and the toner to improve the penetration of the toner into a gap between fibers of the sheet P, and reduces the toner remaining on the transferring and fixing belt 10. While nipping and conveying the sheet P, the transferring and fixing belt 10 and the press tube 43 heat, press and fix the toner image transferred on the sheet P.

In the second embodiment, similarly to the first embodiment, while the transferring and fixing belt 10 and the press tube 44 nip and convey the sheet P, the ultrasonic vibrating device 46 minutely vibrates the sheet P and the toner through the pressure pad 44 and the press tube 43. When the toner image on the transferring and fixing belt 10 is transferred to the sheet P, the penetration of the toner into the sheet P is improved, the residual toner on the transferring and fixing belt 10 is reduced, the picture quality is improved, and the stain of the transferring and fixing belt 10 is reduced. Besides, the penetration of the toner into the sheet P is improved, and the fixing property of the toner image is improved.

Next, a third embodiment will be described. The third embodiment is different from the first embodiment in that a vibrating member is provided on an image carrier member side, not a pressure member side. Further, the third embodiment includes a second vibrating member to vibrate a transferring and fixing belt after a toner image is transferred to a sheet P. In the third embodiment, the same component as the component described in the first embodiment is denoted by the same reference numeral and its detailed description is omitted.

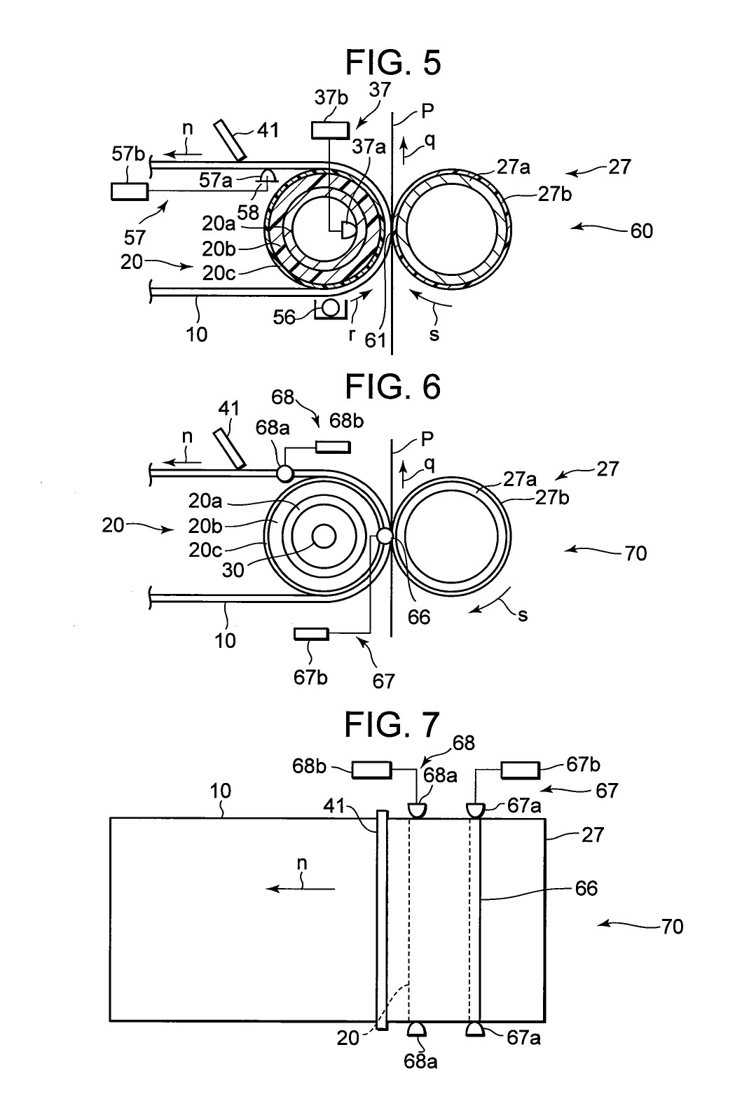

As shown in FIG. 5, an ultrasonic vibrating device 37 contacts with a hollow inner periphery of a heat roller 20 to back up a transferring and fixing belt 10. The ultrasonic vibrating device 37 transmits minute vibrations in the direction of a nip 61 through the heat roller 20 and the transferring and fixing belt 10. A halogen lamp 56 is disposed around the transferring and fixing belt 10 and at a position upstream of the nip 61 and opposite to the heat roller 20.

Besides, in an area extending from the position passing through the nip 61 to a cleaning blade 41, a second ultrasonic vibrating device 57 as a second vibrating member contacts with the inner periphery of the transferring and fixing belt 10. The second ultrasonic vibrating device 57 minutely vibrates the transferring and fixing belt 10 and the residual toner on the transferring and fixing belt 10. In the second ultrasonic vibrating device 57, similarly to the ultrasonic vibrating device 37, plural small ceramic oscillators 57a are disposed on a substrate 58 at regular intervals in parallel to the longitudinal direction of the heat roller 20. The ceramic oscillators 57a oscillate ultrasonic waves of, for example, 20 to 100 kHz by voltage from an AC power source 57b.

A transferring and fixing device 60 includes the transferring and fixing belt 10, the heat roller 20, a press roller 27, the ultrasonic vibrating device 37 and the halogen lamp 56. The halogen lamp 56 directly heats the toner image on the transferring and fixing belt 10, and heats the heat roller 20. In the area where the heat roller 20 backs up, the transferring and fixing device 60 heats the toner image on the transferring and fixing belt 10 to the toner's glass transition temperature or higher before the toner image reaches the nip 61. The transferring and fixing device 60 turns on an AC power source 37b in synchronization with the arrival of the sheet P at the nip 61, and transmits ultrasonic waves oscillated by ceramic oscillators 37a to the toner and the sheet P through the heat roller 20 and the transferring and fixing belt 10.

While passing through the nip 61, the toner image on the transferring and fixing belt 10 heated to the toner's glass transition temperature or higher is transferred to the sheet P by the adhesion. At the same time, the ceramic oscillators 37a minutely vibrate the toner and the sheet P to improve the penetration of the toner into a gap between fibers of the sheet P, and the toner remaining on the transferring and fixing belt 10 is reduced. While nipping and conveying the sheet P, the transferring and fixing belt 10 and the press roller 27 heat, press and fix the toner image transferred on the sheet P.

After passing through the area of the nip 61, the transferring and fixing belt 10 contacts with the second ultrasonic vibrating device 57 which oscillates ultrasonic waves by turning-on of the AC power source 57b. The ultrasonic waves oscillated from the second ultrasonic vibrating device 57 minutely vibrates the residual toner on the transferring and fixing belt 10. The peeling property of the residual toner from the transferring and fixing belt 10 is improved by the minute vibrations. The cleaning blade 41 comes in slide contact with the transferring and fixing belt 10 after contact with the second ultrasonic vibrating device 57, and removes the residual toner on the transferring and fixing belt 10.

In the third embodiment, similarly to the first embodiment, while the transferring and fixing belt 10 and the press roller 27 nip and convey the sheet P, the ultrasonic vibrating device 37 minutely vibrates the toner and the sheet P through the heat roller 20 and the transferring and fixing belt 10. When the toner image on the transferring and fixing belt 10 is transferred to the sheet P, the penetration of the toner into the sheet P is improved to reduce the residual toner on the transferring and fixing belt 10, the picture quality is improved, and the stain of the transferring and fixing belt 10 is prevented. Besides, the penetration of the toner into the sheet P is improved, and the fixing property is improved.

Further, in the third embodiment, after the second ultrasonic vibrating device 57 comes in slide contact with the transferring and fixing belt 10 after passing through the nip 61, the residual toner on the transferring and fixing belt 10 is removed. The peeling property of the residual toner from the transferring and fixing belt 10 is improved, and the cleaning performance of the cleaning blade 41 is improved. Next, a fourth embodiment will be described. The fourth embodiment is different from the third embodiment in that a vibrating member and a second vibrating member are provided outside an image carrier member. In the fourth embodiment, the same component as the component described in the third embodiment is denoted by the same reference numeral, and its detailed description is omitted.

As shown in FIG. 6 and FIG. 7, a pair of ceramic oscillators 67a of an ultrasonic vibrating device 67 contact with both sides of a transferring and fixing belt 10 at almost the center position of a nip 66 between the transferring and fixing belt 10 and a press roller 27. The ultrasonic vibrating device 67 transmits minute vibrations to the nip 66 through the transferring and fixing belt 10. The ceramic oscillators 67a oscillate ultrasonic waves of, for example, 20 to 100 kHz by voltage from an AC power source 67b.

Besides, in an area extending from the position passing through the nip 66 to a cleaning blade 41, a pair of ceramic oscillators 68a of a second ultrasonic vibrating device 68 as a second vibrating member contact with both sides of the transferring and fixing belt 10. The second ultrasonic vibrating device 68 minutely vibrates the transferring and fixing belt 10 and the residual toner on the transferring and fixing belt 10. The ceramic oscillators 68a oscillate ultrasonic waves of, for example, 20 to 100 kHz by voltage from an AC power source 68b. A heat roller 20 holds a halogen lamp 30 in the hollow inside.

A transferring and fixing device 70 includes the transferring and fixing belt 10, the heat roller 20, the press roller 27, the halogen lamp 30, the ultrasonic vibrating device and the second ultrasonic vibrating device 68. The transferring and fixing belt 10 runs in an arrow n direction while both the sides contact with the ultrasonic vibrating device 67 and the second ultrasonic vibrating device 68. The transferring and fixing device 70 turns on the AC power source 67b in synchronization with the arrival of the sheet P at the nip 66, and transmits the ultrasonic waves oscillated by the ceramic oscillators 67a to the toner and the sheet P from both the sides of the transferring and fixing belt 10.

While passing through the nip 66, the toner image heated to the toner's glass transition temperature or higher on the transferring and fixing belt 10 is transferred to the sheet P by the adhesion. At the same time, the ceramic oscillators 67a minutely vibrate the toner and the sheet P to improve the penetration of the toner into a gap between fibers of the sheet P, and the toner remaining on the transferring and fixing belt 10 is reduced. While nipping and conveying the sheet P, the transferring and fixing belt 10 and the press roller 27 heat, press and fix the toner image transferred on the sheet P.

The ultrasonic waves oscillated by the ceramic oscillators 68a by turning-on of the AC power source 68b after passing through the nip 66 are transmitted from both the sides of the transferring and fixing belt 10 to the residual toner. The ultrasonic waves oscillated by the ceramic oscillators 68a minutely vibrate the residual toner on the transferring and fixing belt 10 and improve the peeling property of the residual toner from the transferring and fixing belt 10. The cleaning blade 41 comes in slide contact with the transferring and fixing belt 10 after contact with the ceramic oscillators 68a, and removes the residual toner on the transferring and fixing belt 10.

In the fourth embodiment, the ceramic oscillators 67a minutely vibrate the toner on the transferring and fixing belt 10 and the sheet P from both the sides of the transferring and fixing belt 10 in the area of the nip 66. When the toner image on the transferring and fixing belt 10 is transferred to the sheet P, the penetration of the toner into the sheet P is improved, the residual toner on the transferring and fixing belt 10 is reduced, the picture quality is improved, and the stain of the transferring and fixing belt 10 is prevented. Besides, the penetration of the toner into the sheet P is improved, and the fixing property is improved. Further, after the ceramic oscillators 68a oscillate the ultrasonic waves from both the sides of the transferring and fixing belt 10 after passing through the nip 66, the residual toner on the transferring and fixing belt 10 is removed. The peeling property of the residual toner from the transferring and fixing belt 10 is improved, and the cleaning performance of the cleaning blade 41 is improved.

The present invention is not limited to the above embodiments but can be variously modified within the scope of the invention. For example, the structure of the vibrating member or the second vibrating member is not limited, and a crystal oscillator may be used. The vibration frequency is also not limited as long as an influence is not exerted on the picture quality. Besides, the image carrier member may be an intermediate transfer roller to which an unfixed toner image is intermediately transferred from an image forming section. Further, the heat member may be an infrared heater or an IH heater. Besides, the heat temperature of an unfixed toner by the heat member is not limited.

What is claimed is:

1. A transferring and fixing device comprising:
an image carrier member to hold an unfixed toner image;
a heat member to heat the unfixed toner image on the image carrier member;
a pressure member which comes in press contact with the image carrier member, nips a recording medium with the image carrier member, and presses and conveys the recording medium; and
a vibrating member to transmit vibrations to the recording medium passing through between the image carrier member and the pressure member.

2. The device of claim 1, wherein the vibrating member is an ultrasonic generating device.

3. The device of claim 1, wherein the vibrating member transmits the vibrations to the recording medium through the image carrier member.

4. The device of claim 1, wherein the vibrating member transmits the vibrations to the recording medium through the pressure member.

5. The device of claim 1, wherein the image carrier member is an intermediate transfer member to which the unfixed toner image is transferred from an image forming member.

6. The device of claim 5, wherein the intermediate transfer member is a transferring and fixing belt, and the vibrating member is an ultrasonic generating device to transmit the vibrations to the recording medium through the transferring and fixing belt.

7. The device of claim 6, wherein the ultrasonic generating device oscillates ultrasonic waves to a nip surface between the transferring and fixing belt and the recording medium.

8. The device of claim 6, wherein the ultrasonic generating device oscillates ultrasonic waves to a side surface of the transferring and fixing belt.

9. The device of claim 1, further comprising a second vibrating member to vibrate the image carrier member in an area extending from a position passing through a nip between the image carrier member and the pressure member to a cleaning member.

10. The device of claim 1, wherein the pressure member is a pressure roller, and the vibrating member is an ultrasonic generating device which contacts with the pressure roller.

11. An image forming apparatus comprising:
an image forming member to form an unfixed toner image corresponding to image information;
an image carrier member to hold the unfixed toner image;
a heat member to heat the unfixed toner image on the image carrier member;
a pressure member which comes in press contact with the image carrier member, nips a recording medium with the image carrier member, and presses and conveys the recording medium; and
a vibrating member to transmit vibrations to the recording medium passing through between the image carrier member and the pressure member.

12. The apparatus of claim 11, wherein the vibrating member is an ultrasonic generating device.

13. The apparatus of claim 11, wherein the image forming member forms the unfixed toner image on a photoreceptor, and the image carrier member is an intermediate transfer member to which the unfixed toner image formed on the photoreceptor is transferred.

14. The apparatus of claim 13, wherein the intermediate transfer member is a transferring and fixing belt, and the vibrating member is an ultrasonic generating device to transmit the vibrations to the recording medium through the transferring and fixing belt.

15. The apparatus of claim 14, wherein the ultrasonic generating device oscillates ultrasonic waves to a nip surface between the transferring and fixing belt and the recording medium.

16. The apparatus of claim 14, wherein the ultrasonic generating device oscillates ultrasonic waves to a side surface of the transferring and fixing belt.

17. The apparatus of claim 12, further comprising a second vibrating member to vibrate the image carrier member in an area extending from a position passing through a nip between the image carrier member and the pressure member to a cleaning member.

18. The apparatus of claim 11, wherein the pressure member is a pressure roller, and the vibrating member is an ultrasonic generating device which contacts with the pressure roller.

19. A transferring and fixing method of an image forming apparatus, comprising:
heating an unfixed toner image held by an image carrier member;
transferring the heated unfixed toner image to the recording medium by passing through a recording medium between the image carrier member and a pressure member;
heating, pressing and fixing the unfixed toner image simultaneously with transferring the unfixed toner image to the recording medium; and
transmitting vibrations to the recording medium passing through between the image carrier member and the pressure member.

20. The method of claim 19, further comprising transmitting second vibrations to the image carrier member after passing through a nip area between the image carrier member and the pressure member and before reaching a cleaning member.
